(19) United States
(12) Patent Application Publication
(10) Pub. No.: US 2008/0182018 A1
(43) Pub. Date: Jul. 31, 2008

(54) Method for manufacturing disk, and optical disk

(75) Inventors: Hiroharu Harazaki, Shizuoka (JP); Takayuki Suzuki, Shizuoka (JP)

Correspondence Address: ROBERT J. DEPKE;LEWIS T. STEADMAN, ROCKEY, DEPKE & LYONS, LLC, SUITE 5450 SEARS TOWER, CHICAGO, IL, 60606-6306, US

(73) Assignee: SONY DISC & DIGITAL SOLUTIONS INC.

(21) Appl. No.: 12/011,610

(22) Filed: Jan. 28, 2008

(30) Foreign Application Priority Data
Jan. 30, 2007 (JP) P2007-019306

(51) Int. Cl. B05D 5/06; G11B 7/00

(52) U.S. Cl. 427/162; 428/64.4

(57) ABSTRACT

A method for manufacturing a disk includes the steps of forming a disk substrate, spreading a photoreactive resin on the disk substrate, curing a part of the photoreactive resin on the disk substrate so as to form a cured-in-advance portion at a part of or all of area except an area having a transferred emboss pattern thereon, pressing a stamper against the photoreactive resin spread on the disk substrate while curing the photoreactive resin so as to transfer an emboss pattern formed on the stamper, and releasing the stamper from the photoreactive resin using an attaching portion formed between the cured-in-advance portion and the stamper as a beginning portion of the releasing.

### CROSS REFERENCES TO RELATED APPLICATIONS

The present invention contains subject matter related to Japanese Patent Application JP 2007-019306 filed in the Japanese Patent Office on Jan. 30, 2007, the entire contents of which are incorporated herein by reference.

### BACKGROUND OF THE INVENTION

1. Field of the Invention

The present invention relates to a method for manufacturing a disk and to an optical disk manufactured thereby.

2. Description of the Related Art

In a process of manufacturing an optical disk, an emboss pattern including a pit pattern or a groove pattern formed on a stamper is transferred by pressing the stamper into a photoreactive resin layer spread on a disk substrate while curing the photoreactive resin layer.

Japanese Patent Nos. 3681353 and 3232665 disclose methods used to release a stamper from a disk substrate after such a transferring process.

For example, Japanese Patent No. 3681353 discloses a method using injection-air that is blown into a space that is enlarged by a wedge inserted into an interface between a stamper and a cured resin layer.

Japanese Patent No. 3232665 discloses a method using injection-air which is blown from blowholes provided in a center pin, while raising a disk substrate away from a stamper in the releasing direction using the center pin.

### SUMMARY OF THE INVENTION

In a wedging process for enlarging a space that occurs spontaneously at the interface, problems frequently occur as a result of scratches formed on a portion of the surface of the disk adjacent to the space by rubbing between the wedge and the surface of the disk and as a result of contamination of fragments that are peeled off the resin layer or the disk substrate by rubbing between the wedge and the resin layer or the disk substrate.

In a disk raising process in which a center pin or the like pushes a disk substrate in the releasing direction in order to enlarge a space, a portion from which the releasing starts often still suffers damage although this method does not use a wedge.

It is desirable to provide a method that may release a stamper without such problems.

The method for manufacturing disks according to an embodiment of the present invention includes steps of forming a disk substrate, spreading a photoreactive resin on the disk substrate, curing a part of the photoreactive resin on the disk substrate so as to form a cured-in-advance portion at a part of or all of area except an area having a transferred emboss pattern thereon, pressing a stamper against the photoreactive resin spread on the disk substrate while curing the photoreactive resin so as to transfer an emboss pattern formed on the stamper, and releasing the stamper from the photoreactive resin using an attaching portion between the cured-in-advance portion and the stamper as a beginning portion of the releasing.

Furthermore, in the curing step, the cured-in-advance portion may be formed at a vicinity of the center-hole by curing a part of the photoreactive resin layer disposed on the disk substrate.

Furthermore, in the curing step, the cured-in-advance portion having a larger area than that of the center-hole of the stamper, the cured-in-advance portion around the center-hole of the disk substrate may be formed by curing a part of the photoreactive resin layer.

Furthermore, the photoreactive resin may be an ultraviolet curable resin.

Furthermore, in the releasing step, the stamper may be released from the disk substrate by injection-air blown into a space formed between the stamper and the cured-in-advance portion of the photoreactive resin layer.

The optical disk according to an embodiment of the present invention is manufactured by spreading a photoreactive resin on the disk substrate, curing a part of the photoreactive resin on the disk substrate so as to form a cured-in-advance portion at a part of or all of area except an area having a transferred emboss pattern thereon, pressing a stamper against the photoreactive resin spread on the disk substrate while curing the photoreactive resin so as to transfer an emboss pattern formed on the stamper, releasing the stamper from the photoreactive resin using an attaching portion between the cured-in-advance portion and the stamper as a beginning portion of the releasing, and forming a predetermined layer on the disk substrate having a resin layer in which the emboss pattern is transferred thereon.

In the embodiment of the present invention, in a transferring process for transferring an emboss pattern including a pit pattern to a disk substrate using a stamper, a part of a resin layer is cured in advance to form a certain portion (hereinafter referred to as cured-in-advance portion) where releasing begins. The cured-in-advance portion is formed before the performance of the transferring process in order to successfully release the stamper from a cured resin layer on the disk substrate.

In the transferring process, the resin layer is cured when the stamper is pressed against the resin layer so as to transfer the emboss pattern. Therefore, the resin layer and the stamper are bonded together with a certain strength. At the cured-in-advance portion of the resin layer, however, as it has been already cured, the resin layer and the stamper are not bonded.

Thus, when the stamper is pushed upward in the releasing direction after the transferring process, a space occurs spontaneously at an interface between the cured-in-advance portion and the stamper.

According to the embodiments of the present invention, since a part of a resin layer cured as a cured-in-advance portion of the resin layer on a disk substrate is formed before a transferring process, when one of a stamper and the disk substrate is moved away from the other in the releasing direction after the transferring process for an emboss pattern, a space occurs spontaneously at an interface between the cured-in-advance portion of the resin layer and the stamper. Therefore, for example, blowing of injection-air into the space acting as a portion where the releasing begins allows the stamper to be easily released without a forced separation.

Consequently, a forcible opening operation to form the space using a wedge, a pin, or the like is not needed. Therefore, scratches on the surface of the disk adjacent to the space do not occur and peeled fragments from a resin layer and a substrate do not occur. As a result, high-quality optical disks may be manufactured.

### BRIEF DESCRIPTION OF THE DRAWINGS

FIG. 1 is a flowchart showing a manufacturing process of a disk according to an embodiment of the present invention;

FIGS. 2A to 2C are cross-sectional views of a substrate illustrating the manufacturing process according to the embodiment of the present invention;

FIG. 2D is an enlarged view showing a part of FIG. 2C;

FIGS. 3A, 3B, 3D, and 3E are cross-sectional views of the substrate illustrating the manufacturing process according to the embodiment of the present invention;

FIG. 3C is an enlarged view showing a part of FIG. 3B;

FIG. 4 is a flowchart showing a process for disposing a spacer and a L1 layer according to the embodiment of the present invention;

FIG. 5A is a cross-sectional view of the substrate illustrating a process for forming a cured-in-advance portion according to the embodiment of the present invention;

FIG. 5B is a plan view of the substrate illustrating the process for forming the cured-in-advance portion according to the embodiment of the present invention;

FIG. 6 is a cross-sectional view of the substrate illustrating a transferring process according to the embodiment of the present invention;

FIG. 7 is a cross-sectional view of the substrate illustrating a releasing process according to the embodiment of the present invention;

FIG. 8 is a cross-sectional view of the substrate illustrating the releasing process according to the embodiment of the present invention;

FIG. 9 is a cross-sectional view of a substrate illustrating a transferring process according to another embodiment of the present invention;

FIG. 10 is a cross-sectional view of the substrate illustrating a releasing process according to another embodiment of the present invention;

FIG. 11 is a cross-sectional view of the substrate illustrating the releasing process according to another embodiment of the present invention;

FIG. 12 is a cross-sectional view of a substrate illustrating a transferring process according to still another embodiment of the present invention;

FIG. 13 is a cross-sectional view of the substrate illustrating a releasing process according to still another embodiment of the present invention; and

FIG. 14 is a cross-sectional view of the substrate illustrating the releasing process according to still another embodiment of the present invention.

### DESCRIPTION OF THE PREFERRED EMBODIMENTS

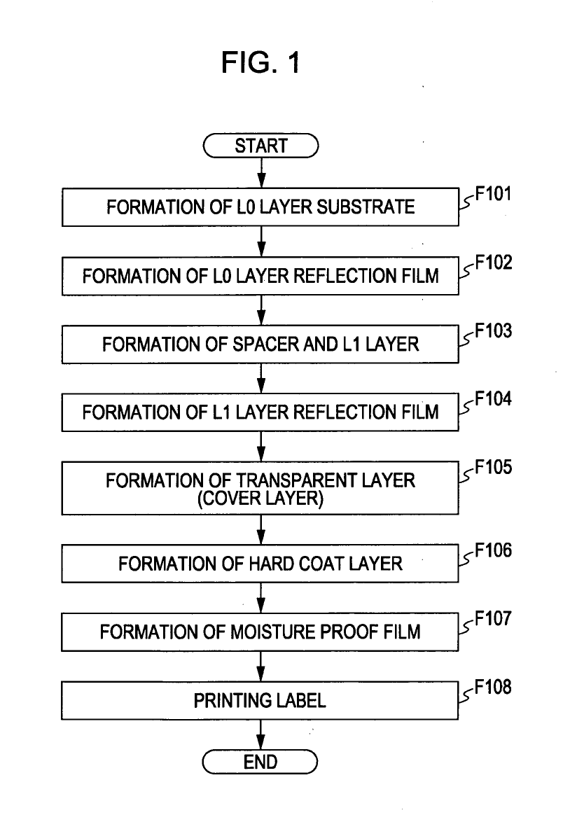

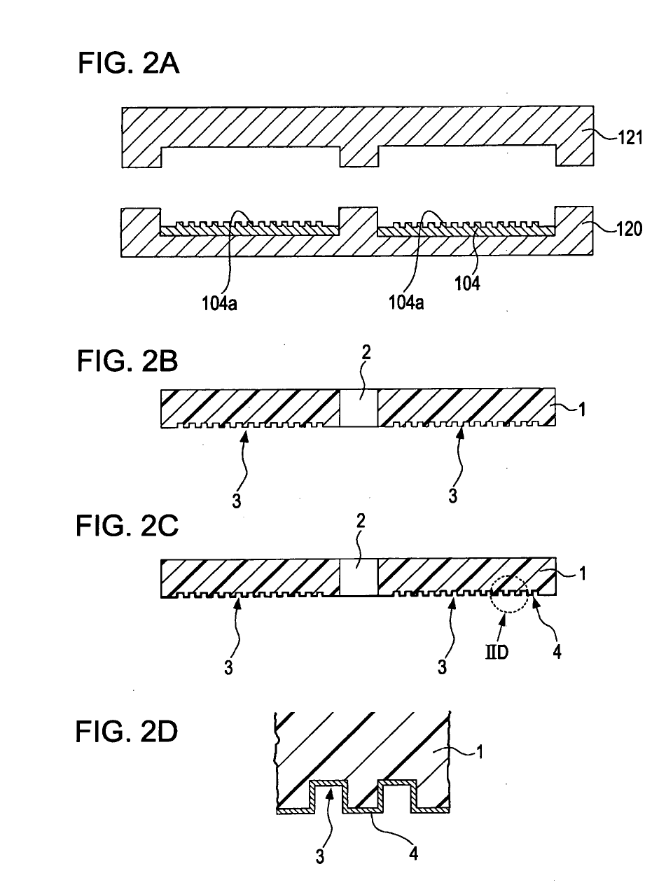

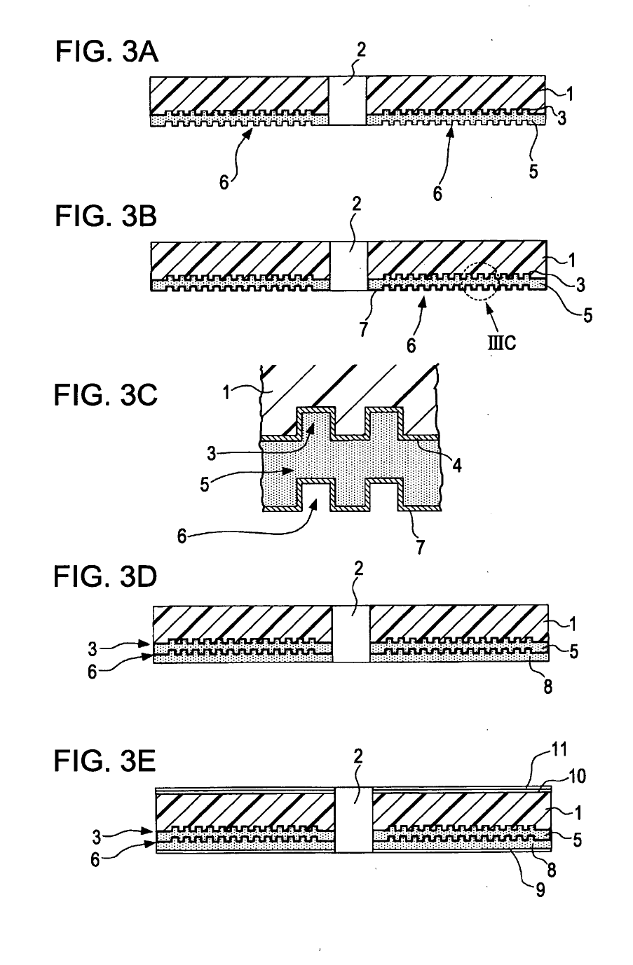

A method for manufacturing a disk of an embodiment of the present invention will be described below. FIG. 1 shows an entire flowchart of manufacturing a disk according to the present embodiment. Now, the entire flowchart shown in FIG. 1 will be described with reference to FIGS. 2A to 3E.

Note that, in the present embodiment, a method for manufacturing a two-layer disk, which is used as a play-only disk, having an L0 layer and an L1 layer as recording layers is described. When the two-layer disk is manufactured, an original disk that has a pit pattern providing information recorded in an L0 layer and another original disk that has another pit pattern providing information recorded in an L1 layer are fabricated in advance. Then a stamper for forming an L0 layer (hereinafter referred to as L0 stamper) and another stamper for forming an L1 layer (hereinafter referred to as L1 stamper) are fabricated using the original disks.

As shown in FIG. 1, the manufacturing process includes steps in which the L0 stamper and the L1 stamper are used to manufacture optical disks.

In the method for manufacturing optical disks of the present embodiment, at a step F101, an L0 layer substrate is formed. For example, a disk substrate composed of a polycarbonate resin is formed by injection molding. The disk substrate formed at this step has a pit pattern acting as an L0 layer and is referred to as an L0 layer substrate 1, hereinafter.

FIG. 2A schematically shows a metallic mold used to form the L0 layer substrate 1. The mold is composed of a lower cavity 120 and an upper cavity 121. On the lower cavity 120, an L0 stamper 104 is disposed to transfer information pits formed on an L0 layer. On the L0 stamper 104, an emboss pattern 104a acting as the information pits is formed.

Note that, in a manufacturing process for play-only disks, the L0 stamper 104 having the emboss pattern 104a formed as emboss pits acting as the information pits is provided. In a manufacturing process of recordable disks (for example, write-once-disks and rewritable disks), a stamper having an emboss pattern for forming a groove (wobbling groove) acting as a recording track may be provided.

The L0 layer substrate 1 is formed by injection molding using such a mold. FIG. 2B shows the L0 layer substrate 1 formed by such a process.

The L0 layer substrate 1 composed of polycarbonate resin has a center-hole 2 at the central position thereof and an information pit pattern (L0 pit pattern 3) on an information readout face thereof. The L0 pit pattern 3 is transferred from the emboss pattern 104a formed on the L0 stamper 104 provided in the mold.

Note here that, in the case of manufacturing write-once-disks or rewritable disks, a groove (spiral groove) is formed instead of the information pits.

Next, at a step F102, a reflection film (L0 layer reflection film 4) is deposited by sputtering on the L0 layer substrate 1 formed as described above. That is, as shown in FIGS. 2C and 2D, the L0 layer reflection film 4 composed of a silver alloy or the like is deposited on a signal readout face having the L0 pit pattern 3 thereon.

Next, at a step F103, a spacer and an L1 layer are formed.

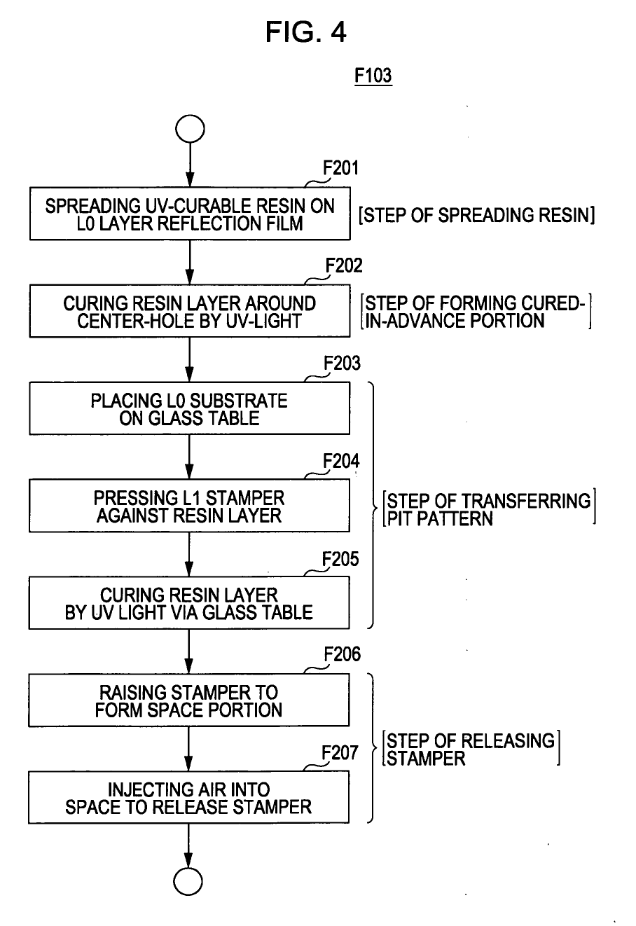

A process for forming the spacer and the L1 layer is a characteristic process of the present embodiment. This process will be described in detail using FIG. 4 and following drawings. Basically, a resin layer which is to be cured by ultraviolet light, i.e., an ultraviolet curable resin layer is spread by spin-coating on the substrate having the L0 layer reflection film 4 deposited thereon, as shown in FIG. 2C. Then the ultraviolet curable resin is cured while being pressed by an L1 layer stamper. When the L1 stamper is released, a spacer 5 and the L1 layer having a pit pattern (L1 pit pattern 6), which represents certain information, are formed on the L0 layer substrate 1 as shown in FIG. 3A.

Next, at a step F104, an L1 layer reflection film 7 is deposited.

That is, as shown in FIGS. 3B and 3C, a semitransparent film (L1 layer reflection film 7) is deposited by sputtering on the L1 pit pattern 6 of the L0 layer substrate 1 on which the spacer 5 and the L1 pit pattern 6 are formed.

Next, at a step F105, as shown in FIG. 3D, a transparent layer 8 (also referred to as cover layer) is formed. For example, an ultraviolet curable resin constituting the cover layer is spread on the substrate by spin-coating and then cured by ultraviolet irradiation so as to form the cover layer 8. Note that the cover layer 8 can also be formed by, for example, bonding a polycarbonate sheet to the substrate.

Then, the substrate shown in FIG. 3E is formed through steps F106, F107, and F108.

That is, at a step F106, a layer acting as a surface treatment layer, hereinafter referred to as hard coat layer 9, is formed on the signal readout face. For example, a material of an ultraviolet curable resin is dropped on the cover layer 8 and spread by spin-coating, and then cured by ultraviolet irradiation so as to form the hard coat layer 9. Note that, however, it may not be necessary to form the hard coat layer 9.

Then, at a step F107, a moisture proof film 10, which prevents entry of moisture, is formed on a label face (the face opposite the information readout face) of the substrate. Note that it may not be necessary to form the moisture proof film 10.

At a step F108, which is the final step, the label face of the disk substrate (L0 layer substrate 1) having the above-mentioned layers thereon is printed by, for example, offset printing. As an example of offset printing, color printing is performed on the label face on which a white coating has been applied over the entirety thereof in advance. Thus, a printed layer 11 is formed.

Then, the optical disk is completed through an inspection process.

At a step F103 for forming the spacer and the L0 layer among the processes from formation of the substrate to completion of the disk of the present embodiment, the stamper is easily released without a forced separation after the transfer of the L1 pit pattern 6.

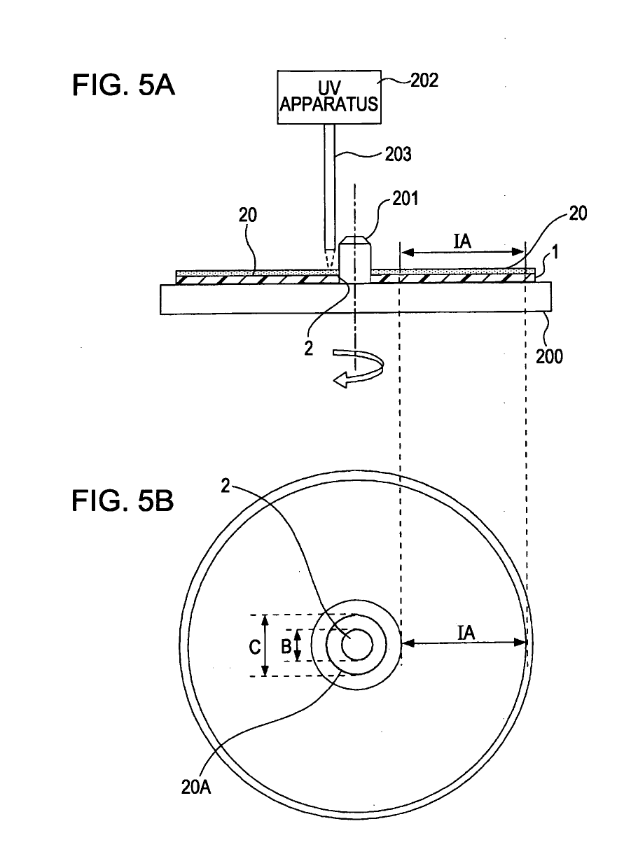

An example of a process for forming the spacer and an L1 layer is shown in FIG. 4 and described with reference to FIGS. 5A to 8.

The process for forming the spacer and the L1 layer, as shown in FIG. 4, includes a step of spreading resin (F201), a step of forming a cured-in-advance portion (F202), steps of transferring the pattern (F203, F204, and F205), and steps of releasing the stamper (F206, F207).

At the step F201 that is the step for spreading resin, an ultraviolet curable resin is dropped to form the spacer on an L0 layer reflection film 4 disposed on an L0 layer substrate 1, as shown in FIGS. 2C and 2D, and spread by spin-coating.

FIG. 5A shows the L0 layer substrate 1 set on a rotation table 200. The L0 layer substrate 1 is positioned using a center-hole 2 thereof and a center-pin 201 provided on the rotation table 200. The center-pin 201 is introduced through the center-hole 2 so as to fix the L0 layer substrate 1 in position. Under such conditions, an ultraviolet curable resin 20 is dropped on the L0 layer substrate 1 from a nozzle (not shown) and the rotation table 200 is rotated at high speed. Thus, the ultraviolet curable resin 20 is spread over the L0 layer substrate 1 as shown in FIG. 5A.

After the spreading of the ultraviolet curable resin 20, which has not yet been cured, the step F202 in which a part of the ultraviolet curable resin 20 is cured is performed.

As shown in FIG. 5A, ultraviolet light, which is emitted from a UV irradiation apparatus 202, is irradiated to a vicinity of a center-hole 2 of the L0 layer substrate 1 in a spot manner using an optical fiber 203. Since the ultraviolet light is irradiated to the table through the optical fiber 203 while the rotation table 200 is rotated, as shown in FIG. 5B, a cured-in-advance portion 20A is formed in a ring shape that surrounds the center-hole 2 in the ultraviolet curable resin 20.

Note that an information area IA is shown in FIGS. 5A and 5B. This information area IA is a region into which an L1 pit pattern 6 is transferred, and the region is composed of a read-in area, data area, and read-out area arranged in this order from the interior side to the exterior side. The cured-in-advance portion 20A is formed in an area separate from the information area IA. That is, the cured-in-advance portion 20A is formed by ultraviolet irradiation in an area which surrounds the center-hole 2 and has a smaller radius than the information area IA.

In the case that a burst “cutting” area (BCA) is formed on the interior side of the read-in area, the cured-in-advance portion 20A is formed in an area having a smaller radius than the BCA.

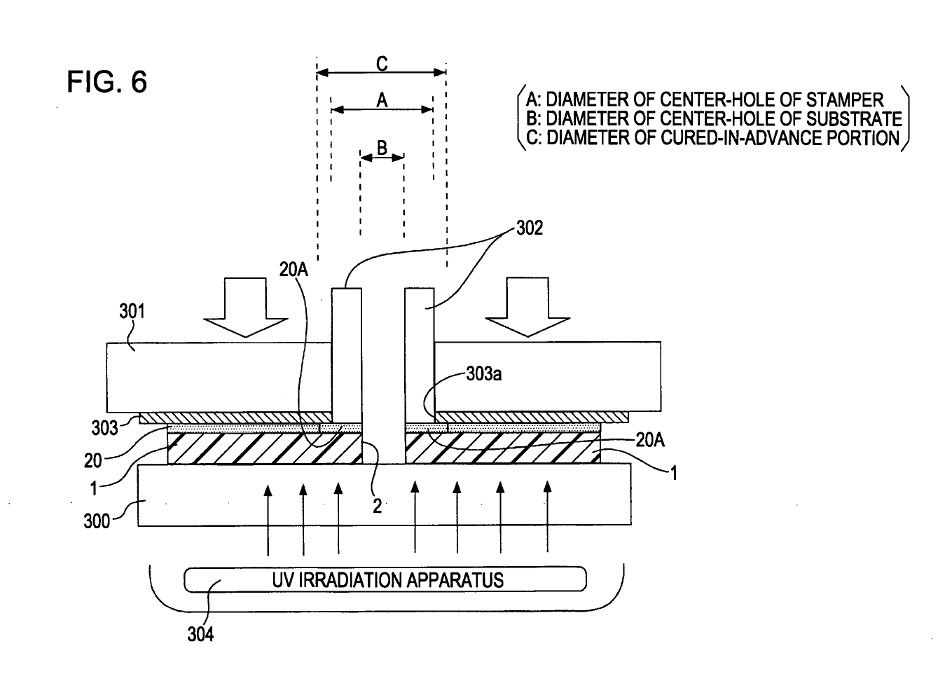

The radius of the cured-in-advance portion 20A is larger than that of a center-hole 303a of an L1 stamper 303 shown in FIG. 6.

As shown in FIG. 5B, when the diameter of the center-hole 2 of the L0 layer substrate 1 is denoted by “B” and the diameter of the cured-in-advance portion 20A is denoted by “C”, the cured-in-advance portion 20A having a diameter of C is formed by ultraviolet spot irradiation of the circular area having an interior radius of B/2 and an exterior radius of C/2. The diameter of the cured-in-advance portion 20A, that is C, is larger than “A”, which is a diameter of the center-hole 303a of the L1 stamper 303 shown in FIG. 6.

Next, transferring steps are performed after the formation of the cured-in-advance portion 20A at the partial curing step. In the transferring steps, at a step F203, the L0 layer substrate 1 is set on a glass table, and at a step F204, the L1 stamper presses against a surface of spread resin on the L0 layer substrate 1. Then at a step F205, ultraviolet light is irradiated to an entire surface of the ultraviolet curable resin 20 so as to cure the resin 20.

This transferring process is shown in FIG. 6. The L0 layer substrate 1 is set on a glass table 300. The L0 layer substrate 1 set on the glass table 300 has a surface on which the ultraviolet curable resin 20 is spread and faces upward.

Above the glass table 300, an ejector 302 and a stamper table 301 are provided in a mechanism (not shown) to move in the upward or downward direction. On the lower face of the stamper table 301, an L1 stamper 303 having the L1 pit pattern is held by vacuum attraction, for example.

The ejector 302 and the stamper table 301 move downward to approach the L0 layer substrate 1 set on the glass table 300. Then, as shown in FIG. 6, the ejector 302 is pushed against an area surrounding the center-hole 2 of the L0 layer substrate 1 while the L1 stamper 303 is pushed into the layer of the ultraviolet curable resin 20.

This embodiment describes a case in which the diameter A of the center-hole 303a of the L1 stamper 303 is larger than the diameter B of the center-hole 2 of the L0 layer substrate 1.

As mentioned above, the diameter C of the cured-in-advance portion 20A formed around the center-hole 2 of the L0 layer substrate 1 is larger than the diameter A of the center-hole 303a of the L1 stamper 303. That is, the lower face of the ejector 302 and a lower face of the most interior part which surrounds the center-hole 303a of the L1 stamper 303 are attached to the cured-in-advance portion 20A.

While the L1 stamper 303 presses on the resin layer of the ultraviolet curable resin 20, ultraviolet light is irradiated from an ultraviolet irradiation apparatus 304 that is positioned under the glass table 300. The ultraviolet light reaches the resin layer of the ultraviolet curable resin 20 through the glass table 300 and the L0 layer substrate 1 and cures the ultraviolet curable resin 20 that has not yet been cured other than the cured-in-advance portion 20A.

Since all of the ultraviolet curable resin 20 is cured by the ultraviolet irradiation, the cured resin works as a spacer and an L1 layer on the L0 layer substrate 1. That is, the cured ultraviolet curable resin 20 works as a spacer 5 shown in FIG. 3A and the surface of the ultraviolet curable resin 20, which is pressed by the L1 stamper 303 and cured, is given an emboss pattern acting as a L1 pit pattern 6.

After curing the ultraviolet curable resin 20, releasing of the L1 stamper 303 is performed. At a step F206 in the releasing process, the L1 stamper 303 is raised while the ejector 302 presses the L0 layer substrate 1 downward so that a space is formed between the L0 layer substrate 1 and the L1 stamper 303. Then at a step F207, the L1 stamper 303 is released using air.

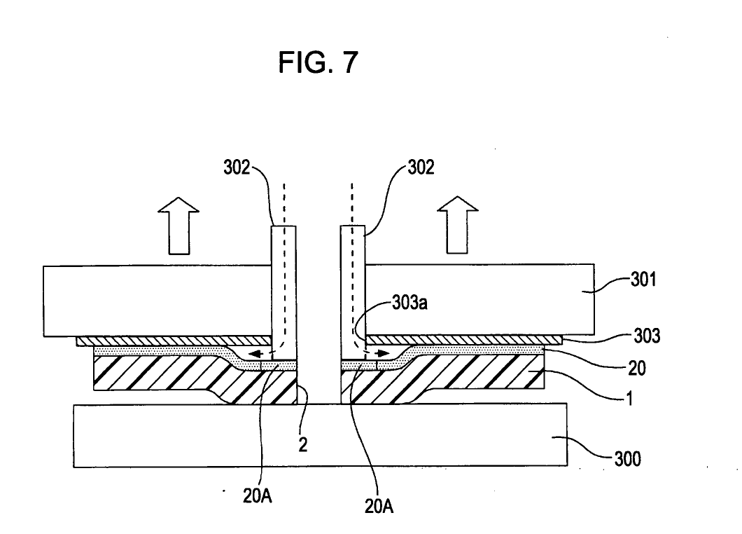

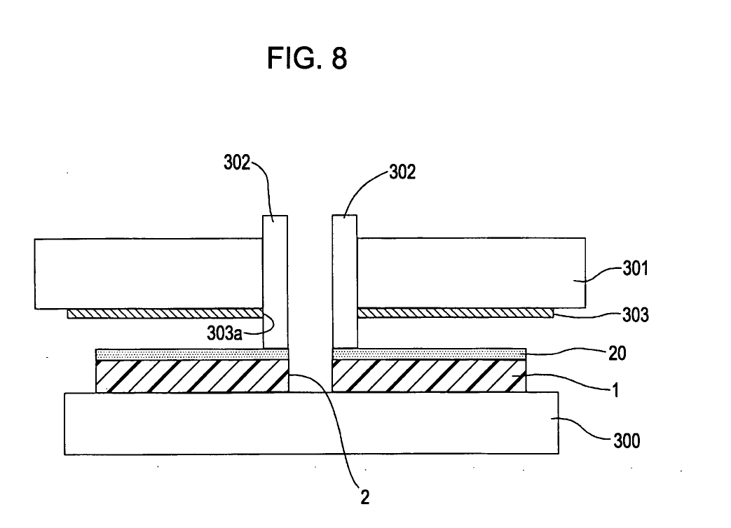

FIGS. 7 and 8 show the releasing process.

FIG. 7 shows the beginning of a step of raising the stamper table 301. Note that a shape of the L0 layer substrate 1 is illustrated in an enlarged manner to be understandable.

Since the stamper table 301 is raised while the L0 layer substrate 1 is pressed by the ejector 302, a force acts in the releasing direction from the L0 layer substrate 1 to the L1 stamper 303. It is, however, not easy to release the resin layer, which was cured in the transferring process, from the L1 stamper 303 because of the adhesion acting therebetween.

In contrast, in the present embodiment, since the most interior part of the L1 stamper 303 contacts the cured-in-advance portion 20A, the most interior part of the L1 stamper 303 is not bonded to the resin layer.

Therefore, as shown in FIG. 7, when the stamper table 301 is raised, a space occurs spontaneously at an interface between the most interior part of the L1 stamper 303 and the cured-in-advance portion 20A. Then, the stamper table 301 is raised while the space is enlarged by air. Openings for air injection are provided at an end portion of the ejector 302 that is used to press the L0 layer substrate 1. The air ejects along broken lines shown in FIG. 7. Since the L1 stamper 303 is raised while the space is enlarged by the air, releasing of the bond between the L1 stamper 303 and the cured resin layer is successfully performed. FIG. 8 shows a situation in which the releasing process of the L1 stamper 303 is completed.

Through the above-mentioned steps, the forming process of the spacer and the L1 layer is completed and the disk substrate shown in FIG. 3A is formed.

After the forming process, a step F104 and the following steps are performed and manufacture of the optical disks is completed.

As shown in the above-mentioned description, since a part of the ultraviolet curable resin 20 on the L0 layer substrate 1 has been cured before transferring so as to form the cured-in-advance portion 20A, when the L1 stamper 303 is moved in the releasing direction after transferring of an emboss pattern using the L1 stamper 303, a space occurs spontaneously at an interface between the surface of the cured-in-advance portion and the L1 stamper 303. Therefore, air-blowing into the space, which acts as a beginning portion for releasing, allows the L1 stamper 303 to be easily released without a forced separation. Thus, a forcible opening operation for forming the space using a wedge, a pin, or the like is not needed. Therefore, problems such as scratching formed on the surface of the space and generating peeled fragments from a resin layer or a substrate do not occur. As a result, high-quality optical disks can be manufactured.

The above-mentioned embodiment describes a releasing process in which the diameter of the center-hole 303a of the L1 stamper 303 is larger than that of the center-hole 2 of the L0 layer substrate 1. In some practical manufacturing processes, however, the diameter of the center-hole 303a of the L1 stamper 303 is equal to or smaller than that of the center-hole 2 of the L0 layer substrate 1. In these cases, a formation of the cured-in-advance portion 20A in a part of the ultraviolet curable resin 20 also allows the stamper to be easily released. Such cases are described below.

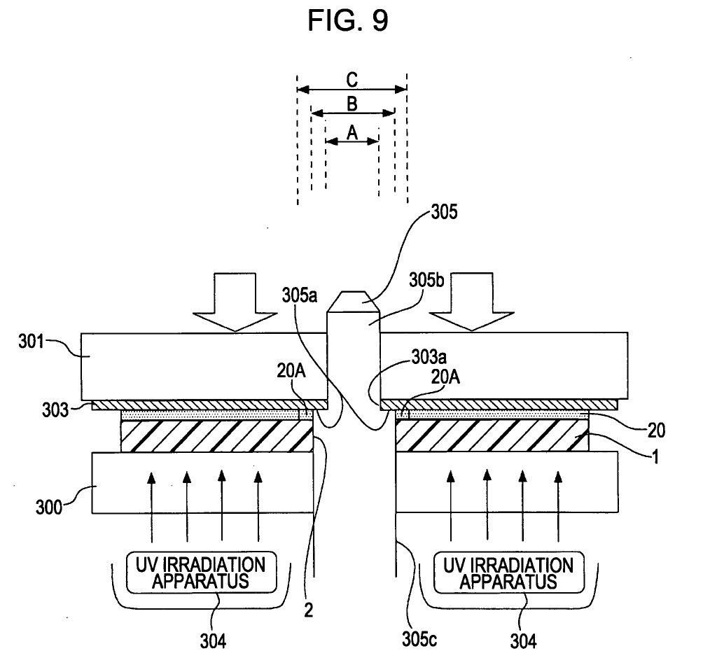

FIGS. 9 to 11 show a substrate in which the diameter A of the center-hole 303a of the L1 stamper 303 is smaller than the diameter B of the center-hole 2 of the L0 layer substrate 1.

In this case, an elevating mechanism for moving the L1 stamper 303 by a stepped-shaft center pin 305 may be employed.

The stepped-shaft center pin 305 has a minor diameter portion 305b, a major diameter portion 305c, and the step portion 303a therebetween. The major diameter portion 305c of the stepped-shaft center pin 305 is introduced through a center-hole of a glass table 300. The major diameter portion 305c is introducible into the center-hole 2 of the L0 layer substrate 1 and the minor diameter portion 305b is introducible into the center-hole 303a of the L1 stamper 303.

The L0 layer substrate 1 is set on the glass table 300 and the major diameter portion 305c of the stepped-shaft center pin 305 is introduced through the center-hole 2 of the L0 layer substrate 1.

Then, as shown in the drawings, the L1 stamper 303 held on a stamper table 301 by vacuum attraction is pressed downward. Since the diameter of the minor diameter portion 305b is introducible into the center-hole 303a of the L1 stamper 303, the most interior part surrounding the center-hole 303a of the L1 stamper 303 is positioned on the step portion 303a.

Since the cured-in-advance portion 20A of the ultraviolet curable resin 20 is formed around the center-hole 2 of the L0 layer substrate 1, an adjacent part to the most interior part of the L1 stamper 303 is positioned on the cured-in-advance portion 20A being adjacent to the stepped portion.

As shown in FIG. 9, while the L1 stamper 303 is pressed against the layer of the ultraviolet curable resin 20, the entire layer of the ultraviolet curable resin 20 is cured by the ultraviolet irradiation emitted from an ultraviolet irradiation apparatus 304.

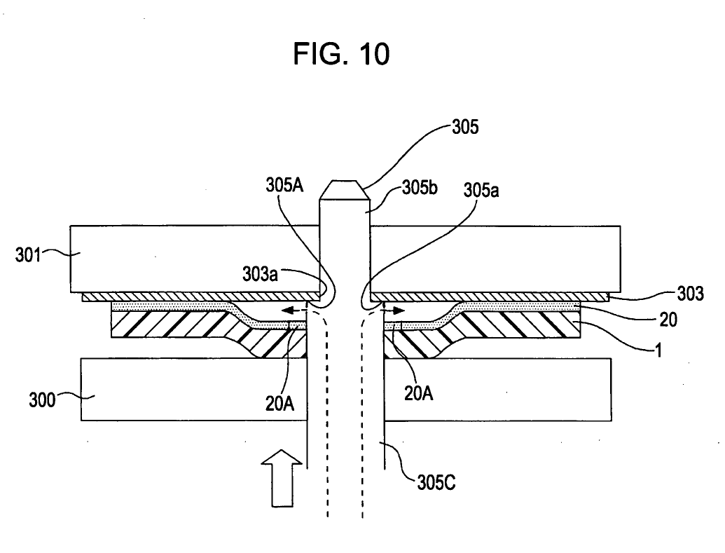

After the curing of the ultraviolet curable resin 20, the L1 stamper 303 is released. At this time, as shown in FIG. 10, the stepped-shaft center pin 305 is pushed upward so as to move the L1 stamper 303 and the stamper table 301 upward by the stepped portion 303.

Since an adhesion between the cured-in-advance portion 20A and the portion of the L1 stamper 303 positioned thereon does not act, a space occurs spontaneously when the L1 stamper 303 is pushed upward. Then, as shown in FIG. 10, air is injected into the space from air-outlet openings provided near the stepped portion 303a of the stepped-shaft center pin 305.

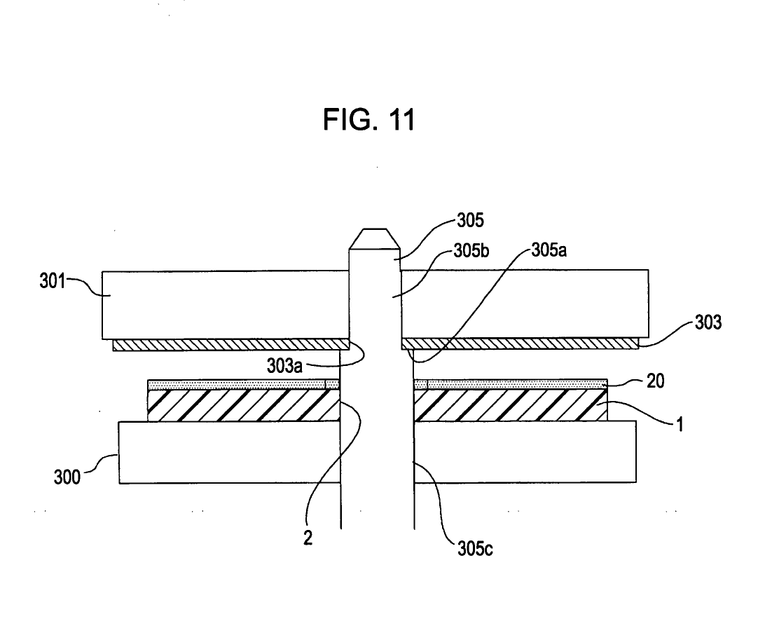

The upward movement of the stepped-shaft center pin 305 while air-blowing allows the L1 stamper 303 to be properly released as shown in FIG. 11.

As mentioned above, the diameter C of the cured-in-advance portion 20A is larger than the diameter A of the center-hole 303a of L1 stamper 303. In the present embodiment, since the diameter A of the center-hole 303a of L1 stamper 303 is smaller than the diameter B of the center-hole 2 of the L0 layer substrate 1, once the cured-in-advance portion 20A is formed, the diameter C thereof is invariably larger than the diameter A. Therefore, the cured-in-advance portion 20A shown in FIG. 5A can be smaller than the region shown in FIG. 6.

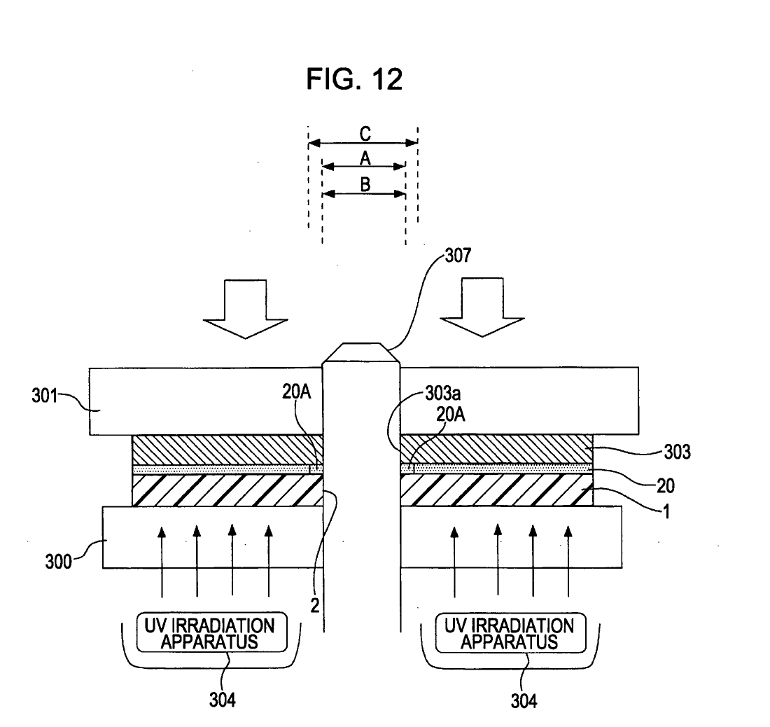

FIGS. 12 to 14 show a substrate in which the diameter A of a center-hole 303a of a L1 stamper 303 is equal to the diameter B of the center-hole 2 of the L0 layer substrate 1.

In this case, a mechanism for moving a stamper table 301 along a center-pin 307 in the upward or downward direction may be employed.

The center-pin 307 is introducible into the center-hole 303a of the L1 stamper 303 and a center-hole 2 of a L0 layer substrate 1. The center-pin 307 is introduced into the center of a glass table 300, and the L0 layer substrate 1 is set on the glass table 300 so that the center-pin 307 is introduced into the center-hole 2 thereof. Then, as shown in the drawings, the L1 stamper 303 held on the stamper table 301 by vacuum attraction is pressed to downward. The stamper table 301 is moved along the center-pin 307 introduced into the center-hole thereof by a mechanism (not shown) for moving along the upward or downward direction.

Since the cured-in-advance portion 20A of the ultraviolet curable resin 20 is formed around the center-hole 2 of the L0 layer substrate 1, the most interior part of the L1 stamper 303, which is pressed against a layer of the ultraviolet curable resin 20, is positioned on the cured-in-advance portion 20A.

As shown in FIG. 12, while the L1 stamper 303 is pressed against the layer of the ultraviolet curable resin 20, the entire layer of the ultraviolet curable resin 20 is cured by the ultraviolet irradiation emitted from an ultraviolet irradiation apparatus 304.

After curing of the ultraviolet curable resin 20, the L1 stamper 303 is released. At first, vacuum attraction by the stamper table 301 for holding the L1 stamper 303 is stopped so that the stamper table 301 alone can be moved upward.

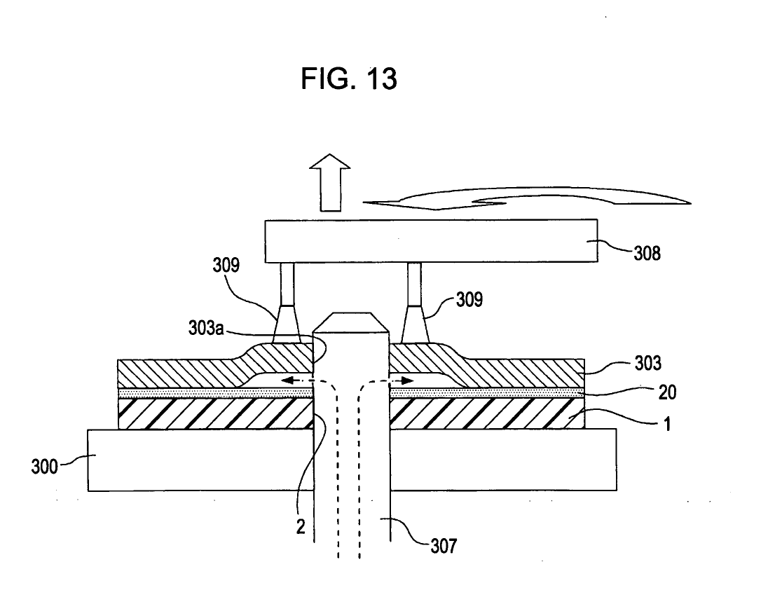

Next, as shown in FIG. 13, a stamper carrier arm 308 having suction cups 309 acting as vacuum chucks are positioned over the L1 stamper 303. Then the stamper carrier arm 308 holds the L1 stamper 303 using the suction cups 309 that attach on at a vicinity of the center-hole 303a. Then the stamper carrier arm 308 is moved upward.

At this time, since an adhesion between the cured-in-advance portion 20A and the portion of the L1 stamper 303 positioned thereon does not act, a space occurs spontaneously when a vicinity part of the center-hole 303a is moved upward by the stamper carrier arm 308. Then, as shown in FIG. 13, air is injected into the space from air-outlet openings provided at the desired position in the center-pin 307.

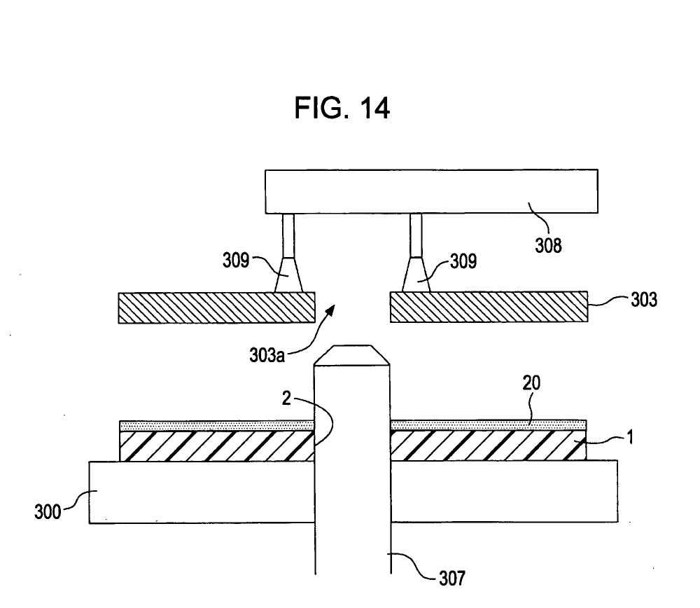

The upward movement of the L1 stamper 303 by the stamper carrier arm 308 during air-blowing allows the L1 stamper 303 to be properly released as shown in FIG. 14.

Also in this case, once the cured-in-advance portion 20A is formed, the diameter C thereof is invariably larger than the diameter A of the center-hole 303a of the L1 stamper 303. Therefore, the cured-in-advance portion 20A, shown in FIG. 5A can be smaller than the region shown in FIG. 6.

While some embodiments of the present invention have been shown and described, the present invention is not limited to those embodiments. In the embodiments, the manufacturing process of play-only disks having two layers is described, however, of course, the methods described in the embodiments for a proper releasing of the stamper may also be used for manufacturing disks having one recording layer or more than two recording layers. Furthermore, the methods described in the embodiments of the present invention may be preferably applied to manufacturing processes of rewritable disks and write-once disks having a groove pattern transferred by a stamper.

Furthermore, the methods described in the embodiments of the present invention may be applied to manufacturing processes of various optical discs such as a blu-ray disc, a digital versatile disc (DVD), and a compact disc (CD).

It should be understood by those skilled in the art that various modifications, combinations, sub-combinations and alterations may occur depending on design requirements and other factors insofar as they are within the scope of the appended claims or the equivalents thereof.

What is claimed is:

1. A method for manufacturing a disk comprising the steps of:
forming a disk substrate;
spreading a photoreactive resin on the disk substrate;
curing a part of the photoreactive resin on the disk substrate so as to form a cured-in-advance portion at a part of or all of area except an area having a transferred emboss pattern thereon;
pressing a stamper against the photoreactive resin spread on the disk substrate while curing the photoreactive resin so as to transfer an emboss pattern formed on the stamper; and
releasing the stamper from the photoreactive resin using an attaching portion formed between the cured-in-advance portion and the stamper as a beginning portion of the releasing.

2. The method for manufacturing a disk according to claim 1, wherein, in the curing step, the cured-in-advance portion is formed at a vicinity of the center-hole by curing a part of the photoreactive resin layer disposed on the disk substrate.

3. The method for manufacturing a disk according to claim 1, wherein, in the curing step, the cured-in-advance portion having a larger area than that of the center-hole of the stamper, the cured-in-advance portion being around the center-hole of the disk substrate is formed by curing a part of the photoreactive resin layer.

4. The method for manufacturing disk according to claim 1, wherein the photoreactive resin is an ultraviolet curable resin.

5. The method for manufacturing disk according to claim 1, wherein, in the releasing step, the stamper is released from the disk substrate by blowing injection-air into a space formed between the stamper and the cured-in-advance portion of the photoreactive resin layer.

6. An optical disk manufactured by
spreading a photoreactive resin on a disk substrate;
curing a part of the photoreactive resin on the disk substrate so as to form a cured-in-advance portion at a part of or all of area except for another area having a transferred emboss pattern thereon;
pressing a stamper to the photoreactive resin spread on the disk substrate while curing the photoreactive resin so as to transfer an emboss pattern formed on the stamper;
releasing the stamper from the photoreactive resin using an attaching portion between the cured-in-advance portion and the stamper as a beginning portion of the releasing; and
forming a predetermined layer on the disk substrate having a resin layer in which the emboss pattern is transferred thereon.
